(19) United States
(12) Patent Application Publication
(10) Pub. No.: US 2005/0048330 A1
(43) Pub. Date: Mar. 3, 2005

(54) Electronic system and power supply method

(75) Inventors: Akihiro Ozeki, Ome-shi (JP); Koji Nakamura, Akiruno-shi (JP); Kyoji Hayashi, Hidaka-shi (JP); Ryoji Ninomiya, Tachikawa-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/927,639

(22) Filed: Aug. 27, 2004

(30) Foreign Application Priority Data
Aug. 29, 2003 (JP) 2003-307639

(51) Int. Cl. H01M 8/04

(52) U.S. Cl. 429/15

(57) ABSTRACT

An electronic system includes an electronic device having a connector to connect an external device and a cell unit having a fuel cell capable of generating power by a chemical reaction. The cell unit is connectable to the electronic device via the connector, configured to receive power for driving an auxiliary of the fuel cell in activating the cell unit from the electronic device via a first pin of the connector, and configured to supply power generated by the fuel cell to the electronic device via a second pin of the connector.

### CROSS-REFERENCE TO RELATED APPLICATIONS

This application is based upon and claims the benefit of priority from prior Japanese Patent Application No. 2003-307639, filed Aug. 29, 2003, the entire contents of which are incorporated herein by reference.

### BACKGROUND OF THE INVENTION

1. Field of the Invention

The present invention relates to an operation control technique for an electronic system capable of operating using, e.g., a direct methanol type fuel cell as a power supply.

2. Description of the Related Art

In recent years, various battery-driven portable electronic devices such as a portable information terminal (e.g., called a PDA: Personal Digital Assistant) and a digital camera have been developed and are widely spread.

Recently, environmental issues receive a great deal of attention, and environmentally friendly batteries have also actively been developed. A well-known battery of this type is a direct methanol fuel cell (to be referred to as a DMFC hereinafter).

The DMFC causes methanol and oxygen supplied as fuels to react with each other, and obtains electric energy from their chemical reaction. The DMFC has a structure in which two electrodes of a porous metal or carbon sandwich an electrolyte. In order not to generate any harmful waste, practical applications of the DMFC are strongly demanded.

The DMFC is equipped with auxiliaries such as a liquid/air pump. In activating the DMFC, these auxiliaries must be driven. For this purpose, the DMFC includes a secondary battery such as a lithium battery. For example, Jpn. Pat. Appln. KOKAI Publication No. 11-154520 discloses a start-up battery (secondary battery) which supplies power to auxiliaries at the start of activating the fuel cell.

The DMFC includes a secondary battery such as the above-mentioned lithium battery, makes the fuel cell unit bulky, and complicates the circuit arrangement. The electrode device side is equipped with a dedicated connector for connecting the fuel cell unit, which also complicates the circuit arrangement. The complicated circuit arrangement makes it difficult to ensure safety.

### BRIEF SUMMARY OF THE INVENTION

Embodiments of the present invention may provide an electronic system and power supply method which simplify the circuit arrangement while ensuring safety.

According to one aspect of the present invention, there is provided an electronic system comprising: an electronic device having an AC adapter connection terminal; and a cell unit having a fuel cell capable of generating power by a chemical reaction and a battery, the cell unit being configured to supply at least one of power from the fuel cell and power from the battery to the electronic device via the AC adapter connection terminal.

According to another aspect of the present invention, there is provided an electronic system comprising: an electronic device having a connector to connect an external device; and a cell unit having a fuel cell capable of generating power by a chemical reaction, the cell unit being connectable to the electronic device via the connector, configured to receive power for driving an auxiliary of the fuel cell in activating the cell unit from the electronic device via a first pin of the connector, and configured to supply power generated by the fuel cell to the electronic device via a second pin of the connector.

According to still another aspect of the present invention, there is provided an electronic system comprising: an electronic device having a battery connector to connect a battery; and a cell unit having a fuel cell capable of generating power by a chemical reaction and a battery, the cell unit being connectable to the electronic device via the battery connector, and configured to supply at least one of power from the fuel cell and power from the battery to the electronic device via a specific pin of the battery connector.

According to still another aspect of the present invention, there is provided an electronic system comprising: an electronic device having a battery connector to connect a battery; and a cell unit having a fuel cell capable of generating power by a chemical reaction and a battery, the cell unit being connectable to the electronic device via the battery connector, configured to supply power generated by the fuel cell to the electronic device via a first pin of the battery connector, and configured to exchange power charged/discharged by the battery with the electronic device via a second pin of the battery connector.

According to still another aspect of the present invention, there is provided an electronic system comprising: an electronic device having a connector to connect an external device; and a cell unit having a fuel cell capable of generating power by a chemical reaction and a battery, the cell unit being connectable to the electronic device via the connector, configured to supply power generated by the fuel cell to the electronic device via a first pin of the connector, and configured to exchange power charged/discharged by the battery with the electronic device via a second pin of the battery connector.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing the outer appearance of an electronic system common to embodiments of the present invention;

FIG. 2 is a block diagram showing the schematic arrangement of a fuel cell unit common to the embodiments of the present invention;

FIG. 3 is a block diagram showing another schematic arrangement of the fuel cell unit;

FIG. 4 is a block diagram showing the schematic arrangement of an electronic device common to the embodiments of the present invention;

FIG. 5 is a block diagram showing a power supply arrangement in an electronic system according to the first embodiment of the present invention;

FIG. 6 is a flow chart showing power supply operation in the first embodiment;

FIG. 7 is a block diagram showing a power supply arrangement in an electronic system according to the second embodiment of the present invention;

FIG. 8 is a flow chart showing power supply operation in the second embodiment;

FIG. 9 is a block diagram showing a power supply arrangement in an electronic system according to the third embodiment of the present invention;

FIG. 10 is a flow chart showing power supply operation in the third embodiment;

FIG. 11 is a block diagram showing a power supply arrangement in an electronic system according to the fourth embodiment of the present invention;

FIG. 12 is a flow chart showing power supply operation in the fourth embodiment;

FIG. 13 is a block diagram showing a power supply arrangement in an electronic system according to the fifth embodiment of the present invention;

FIG. 14 is a flow chart showing power supply operation in the fifth embodiment;

FIG. 15 is a block diagram showing a power supply arrangement in an electronic system according to the sixth embodiment of the present invention; and

FIG. 16 is a flow chart showing power supply operation in the sixth embodiment.

### DETAILED DESCRIPTION OF THE INVENTION

Embodiments of the present invention will be described below with reference to the drawings.

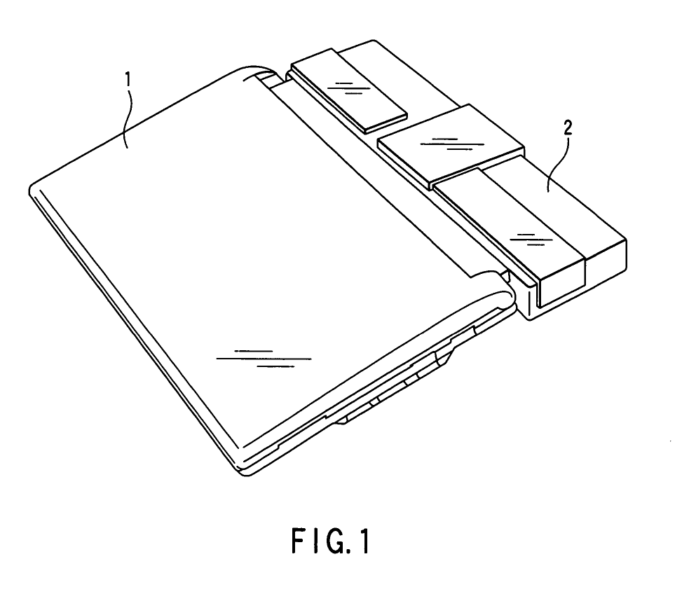

FIG. 1 is a perspective view showing the outer appearance of an electronic system common to the embodiments of the present invention.

As shown in FIG. 1, the electronic system according to the embodiment includes an electronic device 1, and a fuel cell unit 2 freely detachable from the electronic device 1. The electronic device 1 is, e.g., a notebook personal computer in which a lid having an LCD (Liquid Crystal Display) on its inner surface is attached to the main body by a hinge mechanism so as to be freely openable/closable. The electronic device 1 can operate by power supplied from the fuel cell unit 2. The fuel cell unit 2 incorporates a DMFC capable of generating power by a chemical reaction, and a secondary battery capable of being repetitively charged and discharged.

Note that the shape, size, and circuit scale of the fuel cell unit 2 change depending on each embodiment.

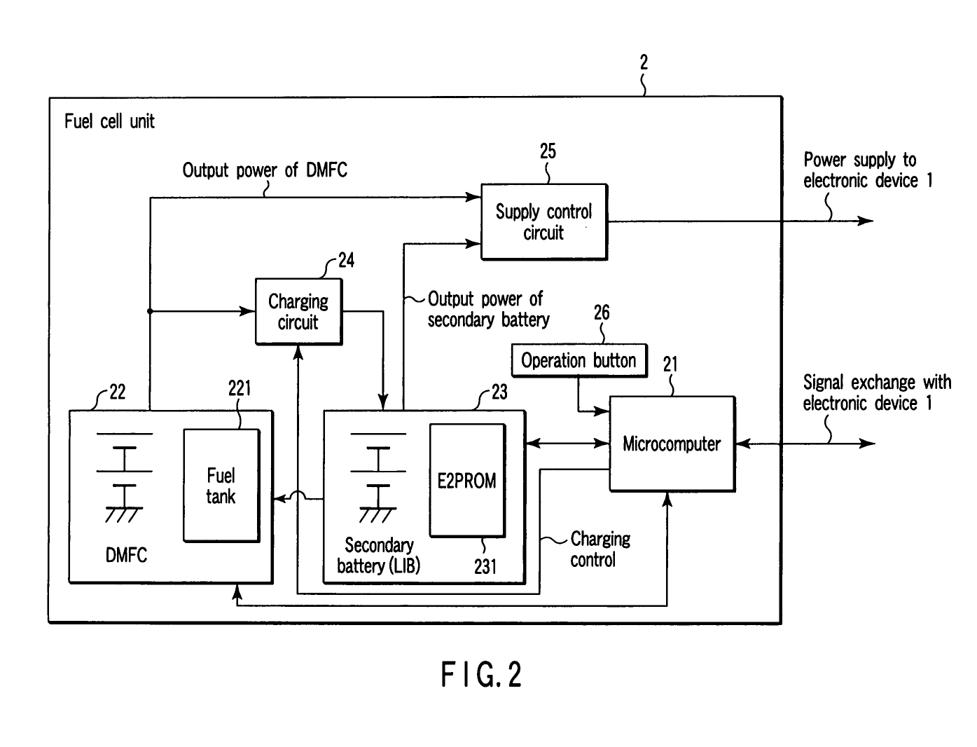

FIG. 2 is a block diagram showing the schematic arrangement of the fuel cell unit 2 common to the embodiments of the present invention.

As shown in FIG. 2, the fuel cell unit 2 includes a microcomputer 21, DMFC 22, secondary battery 23, charging circuit 24, supply control circuit 25, and operation button 26.

The secondary battery 23 and charging circuit 24 may be mounted in or not mounted in the fuel cell unit 2 depending on the embodiment.

The microcomputer 21 controls the operation of the whole fuel cell unit 2, and has a communication function of exchanging signals between the fuel cell unit 2 and the electronic device 1. The microcomputer 21 controls the operations of the DMFC 22 and secondary battery 23 in accordance with an instruction signal from the electronic device 1, and executes processing corresponding to a manipulation of the operation button 26.

The DMFC 22 allows attaching/detaching a cartridge type fuel tank 221. The DMFC 22 outputs power generated upon a chemical reaction between methanol contained in the fuel tank 221 and air (oxygen). This chemical reaction occurs in a reaction portion called a cell stack or the like. In order to efficiently feed methanol and air to the cell stack, the DMFC 22 includes an auxiliary mechanism such as a pump. The DMFC 22 has a mechanism of notifying the microcomputer 21 of mounting/non-mounting of the fuel tank 221, the amount of methanol left in the fuel tank 221, the operating status of the auxiliary mechanism, and the current output power amount.

The secondary battery 23 accumulates power output from the DMFC 22 via the charging circuit 24, and outputs the accumulated power in accordance with an instruction from the microcomputer 21. The secondary battery 23 includes an EEPROM 231 which holds basic information representing the discharging characteristic or the like. The EEPROM 231 can be accessed from the microcomputer 21, and the secondary battery 23 has a mechanism of notifying the microcomputer 21 of the current output voltage value and output current value. The microcomputer 21 calculates the remaining battery amount of the secondary battery 23 from basic information read out from the EEPROM 231 and the output voltage value and output current value sent from the secondary battery. The microcomputer 21 notifies the electronic device 1 of the calculated value. In this case, the secondary battery 23 is assumed to be a lithium battery (LIB).

The charging circuit 24 charges the secondary battery 23 by using power output from the DMFC 22. Whether to charge the secondary battery 23 or not is controlled by the microcomputer 21.

The supply control circuit 25 externally outputs power from the DMFC 22 and secondary battery 23 in accordance with the situation.

The operation button 26 is a dedicated button for designating the operation stop of the DMFC 22 or entire fuel cell unit 2. The same function as the operation button may be implemented by a button provided by an application on the LCD screen of the electronic device 1, or may be implemented by holding the power button of the electronic device 1 down for a certain time (predetermined time or more).

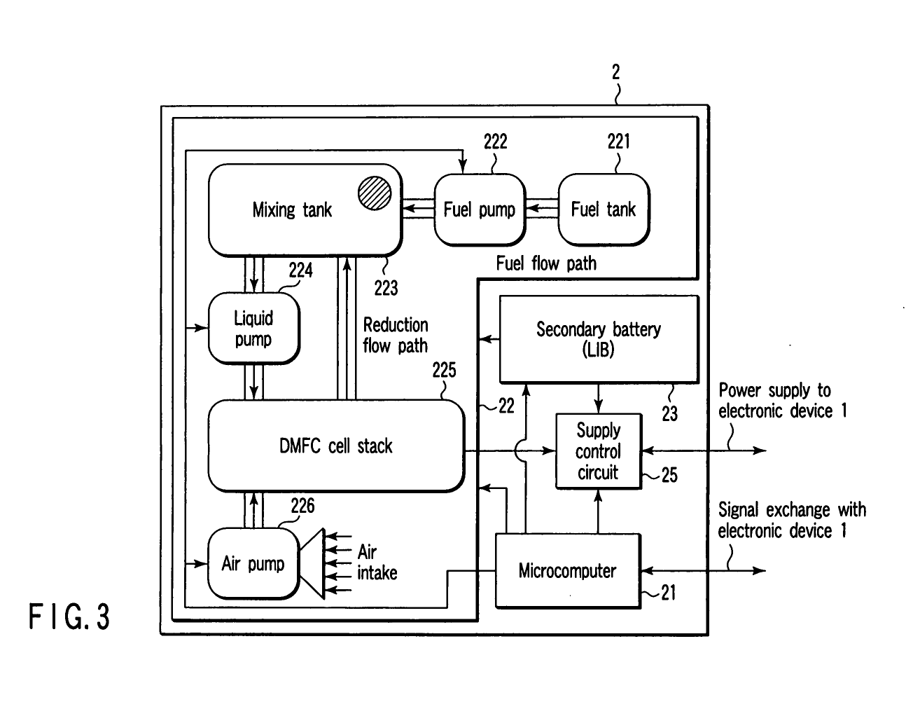

FIG. 3 is a block diagram showing another schematic arrangement of the fuel cell unit 2. The same reference numerals as in FIG. 2 denote the same parts.

As shown in FIG. 3, the DMFC 22 includes the fuel tank 221, a fuel pump 222, a mixing tank 223, a liquid pump 224, a DMFC cell stack 225, and an air pump 226.

The methanol in the fuel tank 221 is fed into the mixing tank 223 by the fuel pump 222. The methanol is also fed into the DMFC cell stack 225 by the liquid pump 224. Air is fed into the DMFC cell stack 225 by the air pump 226, and the oxygen in air and the methanol react with each other to generate power.

The microcomputer 21 controls to drive auxiliaries such as the fuel pump 222, liquid pump 224, air pump 226, and fan by power from the secondary battery 23 in accordance with an activation instruction signal transmitted from the electronic device 1. Further, the microcomputer 21 controls the supply control circuit 25 so as to supply power output from the DMFC cell stack 225 or secondary battery 23 to the electronic device 1. The microcomputer 21 controls to charge the secondary battery 23 before the operation of the DMFC 22 stops in accordance with a stop instruction signal transmitted from the electronic device 1.

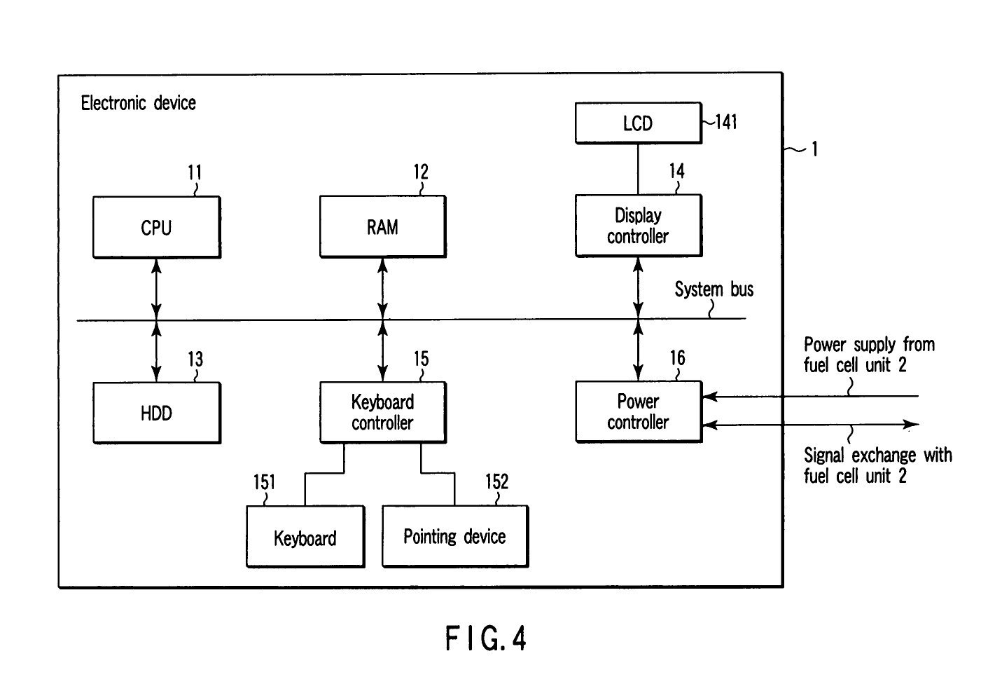

FIG. 4 is a block diagram showing the schematic arrangement of the electronic device 1 common to the embodiments of the present invention.

As shown in FIG. 4, in the electronic device 1, a CPU 11, RAM (main memory) 12, HDD 13, display controller 14, keyboard controller 15, and power controller 16 are connected to a system bus.

The CPU 11 controls the operation of the whole electronic device 1, and executes various programs stored in the RAM 12. The RAM 12 is a memory device serving as the main memory of the electronic device 1. The RAM 12 stores various programs to be executed by the CPU 11 and various data used for these programs. The HDD 13 is a memory device serving as the external memory of the electronic device 1. As the auxiliary device of the RAM 12, the HDD 13 stores various programs and various data.

The display controller 14 controls the output side of the user interface in the electronic device 1. The display controller 14 controls to display image data created by the CPU 11 on an LCD 141. The keyboard controller 15 controls the input side of the user interface in the electronic device 1. The keyboard controller 15 converts a manipulation on a keyboard 151 or pointing device 152 into a numerical value, and transfers the numerical value to the CPU 11 via an internal register.

The power controller 16 controls power supply to each portion within the electronic device 1. The power controller 16 has a power reception function of receiving power supply from the fuel cell unit 2, and a communication function of exchanging signals between the electronic device 1 and the fuel cell unit 2. The partner in the fuel cell unit 2 that exchanges signals with the power controller 16 is the microcomputer 21 shown in FIGS. 2 and 3.

Particularly, the microcomputer 21 of the fuel cell unit 2 and the power controller 16 of the electronic device 1 communicate with each other via a cable or by radio. The electronic device 1 is notified as state information of the states of the DMFC 22 and secondary battery 23 incorporated in the fuel cell unit 2. The electronic device 1 executes operation control based on the notified states.

The first to sixth embodiments will be described.

(First Embodiment)

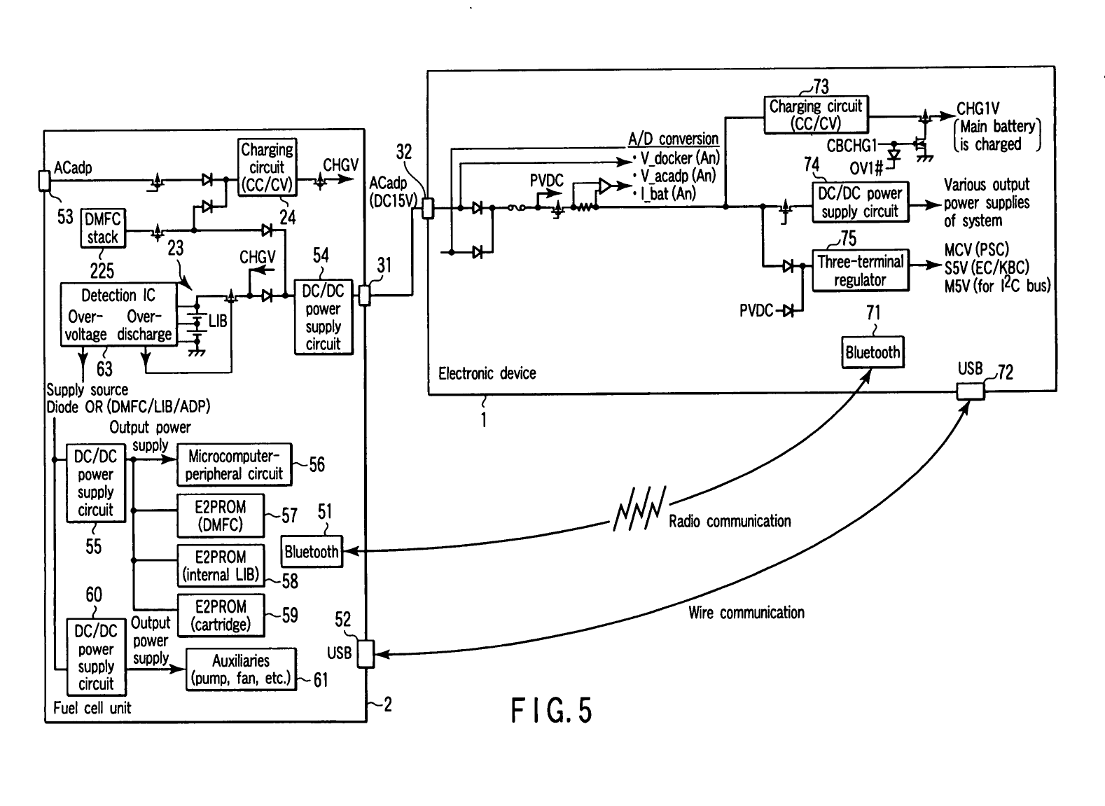

FIG. 5 is a block diagram showing a power supply arrangement in an electronic system according to the first embodiment of the present invention.

In the first embodiment, power is supplied from a fuel cell unit 2 to an electronic device 1 by utilizing an existing AC adapter connection terminal (AC power input terminal) 32 attached to the main body of the electronic device 1.

In addition to a DMFC cell stack 225, secondary battery 23, and charging circuit (for the secondary battery) 24, the fuel cell unit 2 includes a power output terminal 31, Bluetooth® communication portion 51, USB communication portion 52, AC adapter connection terminal (AC power input terminal) 53, DC/DC power supply circuit 54, DC/DC power supply circuit 55, microcomputer peripheral circuit 56, DMFC E²PROM 57, secondary battery E²PROM 58, cartridge E²PROM 59, DC/DC power supply circuit 60, auxiliaries (pump, fan, and the like) 61, and detection IC 63.

The electronic device 1 includes the AC adapter connection terminal (AC power input terminal) 32, a Bluetooth communication portion 71, a USB communication portion 72, a charging circuit 73, a DC/DC power supply circuit 74, and a three-terminal regulator 75.

The power output terminal 31 of the fuel cell unit 2 and the AC adapter connection terminal 32 of the electronic device 1 are electrically connected via a cable or the like. The power output terminal 31 and AC adapter connection terminal 32 may be directly connected without any cable or the like.

In the fuel cell unit 2, power input from the AC adapter connection terminal 53 is supplied to the charging circuit 24. Power generated by the DMFC cell stack 225 is supplied to the charging circuit 24 and DC/DC power supply circuit 54. Power from the AC adapter connection terminal 32 and power from the DMFC cell stack 225 are selectively supplied to the charging circuit 24 via a diode OR circuit. The charging circuit 24 charges the secondary battery 23 with the supplied power.

The detection IC 63 detects an overvoltage/overdischarge in the secondary battery 23, and controls output of power from the secondary battery in accordance with the detection result. Power from the DMFC cell stack 225 and power from the secondary battery 23 are selectively supplied to the DC/DC power supply circuit 54 via the diode OR circuit. The DC/DC power supply circuit 54 generates power of a voltage (DC 15 V) necessary for the operation of the electronic device 1 from the supplied power, and outputs the generated power. Power output from the DC/DC power supply circuit 54 is supplied to the electronic device 1 via the power output terminal 31 and AC adapter connection terminal 32.

Power from the DMFC cell stack 225, power from the secondary battery 23, and power from the AC adapter connection terminal 53 are selectively supplied to the DC/DC power supply circuits 55 and 60 via the diode OR circuit. The DC/DC power supply circuit 55 generates power of a voltage necessary for the operation of a microcomputer or the like from the supplied power, and supplies the generated power to the microcomputer peripheral circuit 56, DMFC E²PROM 57, secondary battery E²PROM 58, and cartridge E²PROM 59.

A microcomputer (corresponding to the microcomputer 21 in FIGS. 2 and 3) in the fuel cell unit 2 notifies the electronic device 1 of various pieces of information in the fuel cell unit 2 via the Bluetooth communication portion 51 or USB communication portion 52. Information notified in this case includes a message that the type of power supply is a fuel cell, the power generation capacity, the remaining fuel amount of the DMFC cell stack 225, and the remaining amount of the secondary battery 23. When the microcomputer in the fuel cell unit 2 is instructed to, for example, stop/start the DMFC or stop/start charging, by the electronic device 1 via the Bluetooth communication portion 51 or USB communication portion 52, the microcomputer complies with the instruction.

In the electronic device 1, power input from the AC adapter connection terminal 32 is supplied to the charging circuit 73, DC/DC power supply circuit 74, and three-terminal regulator 75. The charging circuit 73 charges the main battery by the supplied power. The DC/DC power supply circuit 74 generates and outputs voltages necessary for various output power supplies. The three-terminal regulator 75 generates and outputs voltages necessary for a power supply controller, EC/KBC (Embedded Controller/Keyboard Controller), I²C bus, and the like.

When various pieces of information transmitted from the fuel cell unit 2 are received by the Bluetooth communication portion 71 or USB communication portion 72, a CPU (corresponding to the CPU 11 in FIG. 4) in the electronic device 1 performs control (power saving control or the like) on the power supply of the electronic device 1 in accordance with the information, and displays a window representing the state of the fuel cell unit 2 on the LCD. The CPU also sends an instruction to stop/start the DMFC or stop/start charging to the fuel cell unit 2 via the Bluetooth communication portion 71 or USB communication portion 72 in accordance with the contents of an instruction from the user who has seen the displayed state, or the determination result of the CPU.

In general, the electronic device 1 operates upon recognizing that an AC adapter is connected to the AC adapter connection terminal. The fuel cell unit 2 desirably always supplies stable power to the electronic device 1, similar to the AC adapter. Since the power supply is a fuel cell, stable power is not always supplied to the electronic device 1. For this reason, the fuel cell unit 2 and electronic device 1 cooperate with each other to exchange various pieces of information via their Bluetooth communication portions or USB communication portions, thereby guaranteeing the safety of the overall system.

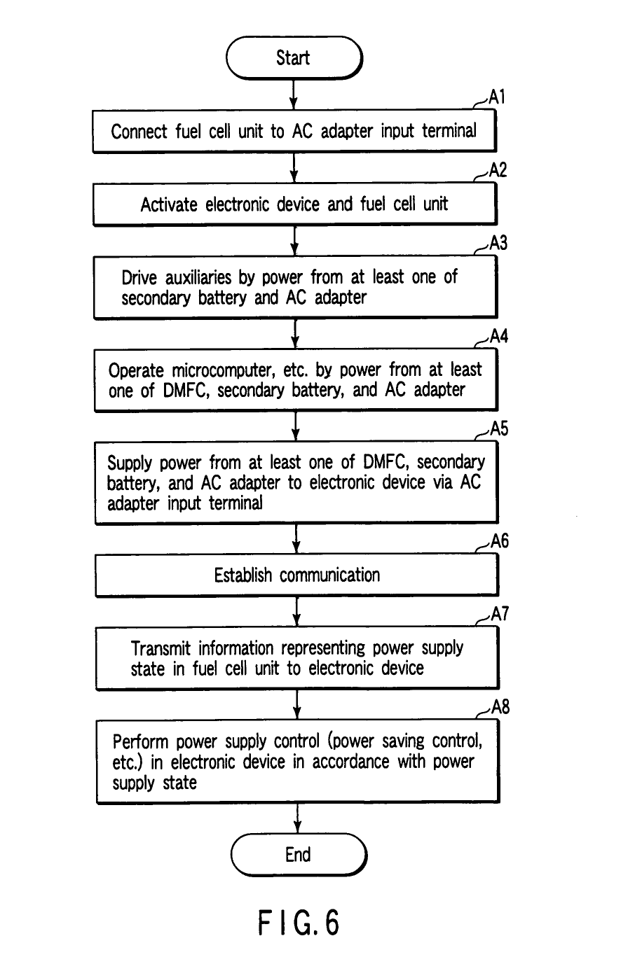

Power supply operation in the first embodiment will be explained with reference to the flow chart of FIG. 6.

When the fuel cell unit 2 is connected to the AC adapter connection terminal 32 via the power output terminal 31 (step A1) and the electronic device 1 and fuel cell unit 2 are activated (step A2), the auxiliaries 61 are driven by power from at least one of the secondary battery and AC adapter (step A3). As a result, the DMFC cell stack 225 is activated.

The microcomputer peripheral circuit 56 and the like operate by power from at least one of the DMFC cell stack 225, secondary battery 23, and AC adapter (step A4). Power from at least one of the DMFC cell stack 225, secondary battery 23, and AC adapter is supplied to the electronic device 1 via the power output terminal 31 and AC adapter connection terminal 32 (step A5).

Radio communication or wire communication is established between the electronic device 1 and the fuel cell unit 2 (step A6). Information representing various pieces of information on the power supply of the fuel cell unit 2 (e.g., a message that the type of power supply is a fuel cell, the power generation capacity, the remaining fuel amount of the DMFC cell stack 225, and the remaining amount of the secondary battery 23) is transmitted to the electronic device 1 (step A7).

In accordance with the information representing the power supply state, the electronic device 1 performs control (power saving control or the like) on the power supply of the electronic device 1, and displays a window representing the state of the fuel cell unit 2 on the LCD (step A8). The electronic device 1 also performs processing of sending an instruction to stop/start the DMFC or stop/start charging to the fuel cell unit 2 via the Bluetooth communication portion 71 or USB communication portion 72 in accordance with the contents of an instruction from the user who has seen the displayed state, or the determination result of the CPU.

According to the first embodiment, power can be supplied from the fuel cell unit 2 to the electronic device 1 by utilizing the existing AC adapter connection terminal (AC power input terminal) attached to the main body of the electronic device 1. In this case, the system can be implemented with a simple arrangement without any great circuit change in the existing electronic device 1. Since the AC adapter and fuel cell unit 2 can be selectively connected via the AC adapter connection terminal, the convenience for the user improves. Further, the safety can be enhanced by cooperation between the electronic device 1 and the fuel cell unit 2 via communication.

The above-described technique of cooperation between the electronic device 1 and the fuel cell unit 2 via communication can be applied to the following second to sixth embodiments.

(Second Embodiment)

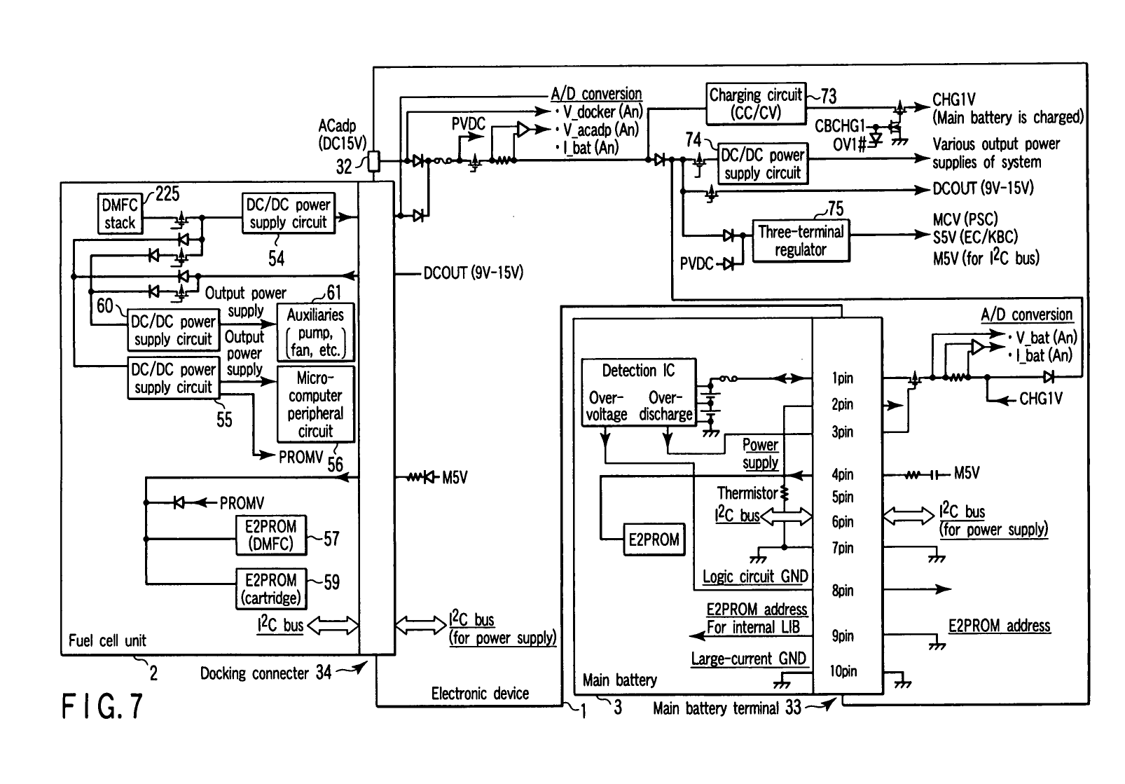

FIG. 7 is a block diagram showing a power supply arrangement in an electronic system according to the second embodiment of the present invention. The same reference numerals as in the above embodiment denote the same parts.

In the second embodiment, power is supplied from a fuel cell unit 2 to an electronic device 1 by utilizing an existing docking connector 34 attached to the main body of the electronic device 1. The docking connector 34 is a connector for originally connecting a docker serving as an external device in order to expand the functions of the electronic device 1.

The fuel cell unit 2 incorporates neither a secondary battery nor its associated charging circuit. In activating the fuel cell unit 2, power for driving auxiliaries is supplied from the electronic device 1 via an existing pin of the docking connector 34. Power can also be supplied from the electronic device 1 to an existing pin of the docking connector 34 to a microcomputer or the like in the fuel cell unit 2. Power can be further supplied from the electronic device 1 to a DMFC E²PROM 57, cartridge E²PROM 59, and I²C bus via pins newly attached to the docking connector 34. The electronic device 1 is connected to a main battery 3 via a main battery terminal 33. Power is supplied to the fuel cell unit 2 by using the main battery 3. This arrangement can simplify the arrangement of the fuel cell unit 2.

A DC/DC power supply circuit 54 in the fuel cell unit 2 generates power of a voltage necessary for the operation of the electronic device 1 from power supplied from a DMFC cell stack 225, and outputs the generated power. Power output from the DC/DC power supply circuit 54 is supplied to the electronic device 1 via an existing pin of the docking connector 34.

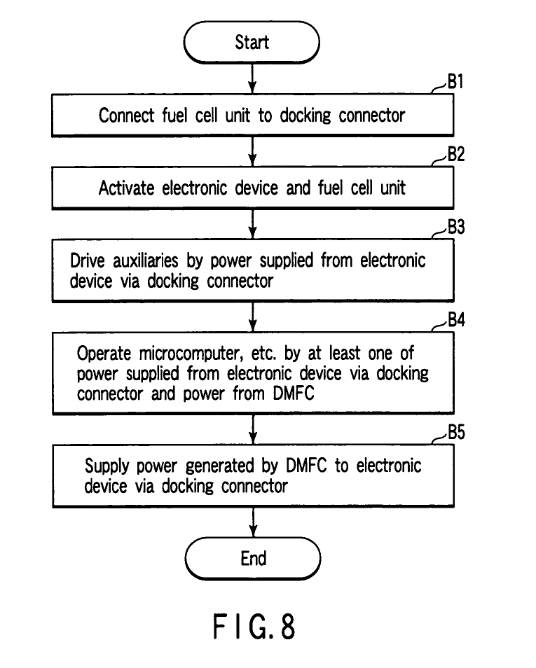

Power supply operation in the second embodiment will be explained with reference to the flow chart of FIG. 8.

When the fuel cell unit 2 is connected to the docking connector 34 (step B1) and the electronic device 1 and fuel cell unit 2 are activated (step B2), auxiliaries 61 are driven by power supplied from the electronic device 1 via the docking connector 34 (step B3). Accordingly, the DMFC cell stack 225 is activated.

A microcomputer peripheral circuit 56 and the like operate by power supplied from the electronic device 1 via the docking connector 34 (step B4). Power generated by the DMFC cell stack 225 is supplied to the electronic device 1 via the docking connector 34 (step B5).

According to the second embodiment, the existing docking connector attached to the main body of the electronic device 1 can be used to activate the auxiliaries of the fuel cell unit 2 by power from the electronic device 1, and supply power from the fuel cell unit 2 to the electronic device 1. In this case, the system can be implemented with a simple arrangement without any great circuit change in the existing electronic device 1. Since no secondary battery or the like is mounted in the fuel cell unit 2, the arrangement of the fuel cell unit 2 becomes simpler. Since the docker and fuel cell unit 2 can be selectively connected via the docking connector, the convenience for the user improves. The safety can be enhanced by cooperation between the electronic device 1 and the fuel cell unit 2 via communication.

(Third Embodiment)

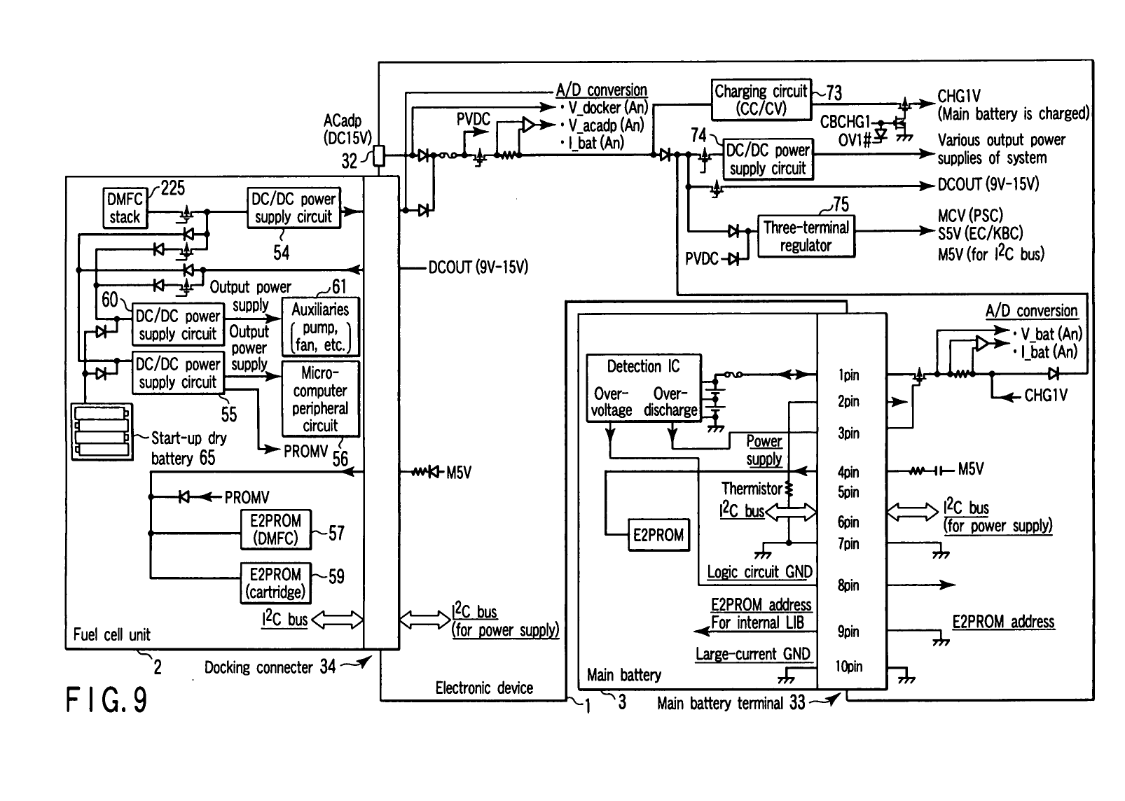

FIG. 9 is a block diagram showing a power supply arrangement in an electronic system according to the third embodiment of the present invention. The same reference numerals as in the above embodiments denote the same parts.

In the third embodiment, a start-up dry battery 65 is additionally installed in a fuel cell unit 2 in the arrangement of the second embodiment described above.

The start-up dry battery 65 is a dry battery used to activate the fuel cell unit 2. For example, when no power is supplied from an electronic device 1 via a docking connector (or power does not reach a predetermined value) in activating the fuel cell unit 2, power from the start-up dry battery 65 is used to activate auxiliaries. The start-up dry battery 65 can supply power even to a microcomputer peripheral circuit 56.

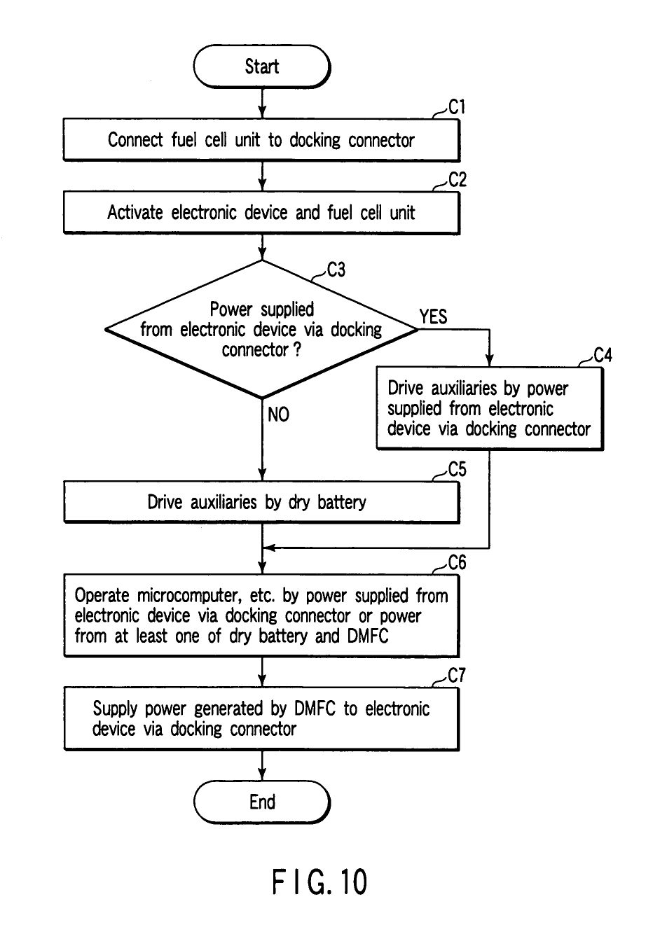

Power supply operation in the third embodiment will be explained with reference to the flow chart of FIG. 10.

When the fuel cell unit 2 is connected to a docking connector 34 (step C1) and the electronic device 1 and fuel cell unit 2 are activated (step C2), auxiliaries 61 are driven. If power is supplied from the electronic device 1 via the docking connector 34 (YES in step C3), the auxiliaries 61 are driven by power from the electronic device 1 without using the start-up dry battery 65 (step C4). If no power is supplied from the electronic device 1 via the docking connector 34 (NO in step C3), the auxiliaries 61 are driven by power from the start-up dry battery 65 (step C5). As a result, the DMFC cell stack 225 is activated.

The microcomputer peripheral circuit 56 and the like operate by power supplied from the electronic device 1 via the docking connector 34 or power from at least one of the start-up dry battery 65 and DMFC cell stack 225 (step C6). Power generated by the DMFC cell stack 225 is supplied to the electronic device 1 via the docking connector 34 (step C7).

According to the third embodiment, the start-up dry battery 65 is installed in the fuel cell unit 2. Even when no power is supplied from the electronic device 1 via the docking connector 34, the auxiliaries 61 can be driven by power from the start-up dry battery 65, preventing a situation in which the DMFC cell stack 225 cannot be activated though fuel exists.

(Fourth Embodiment)

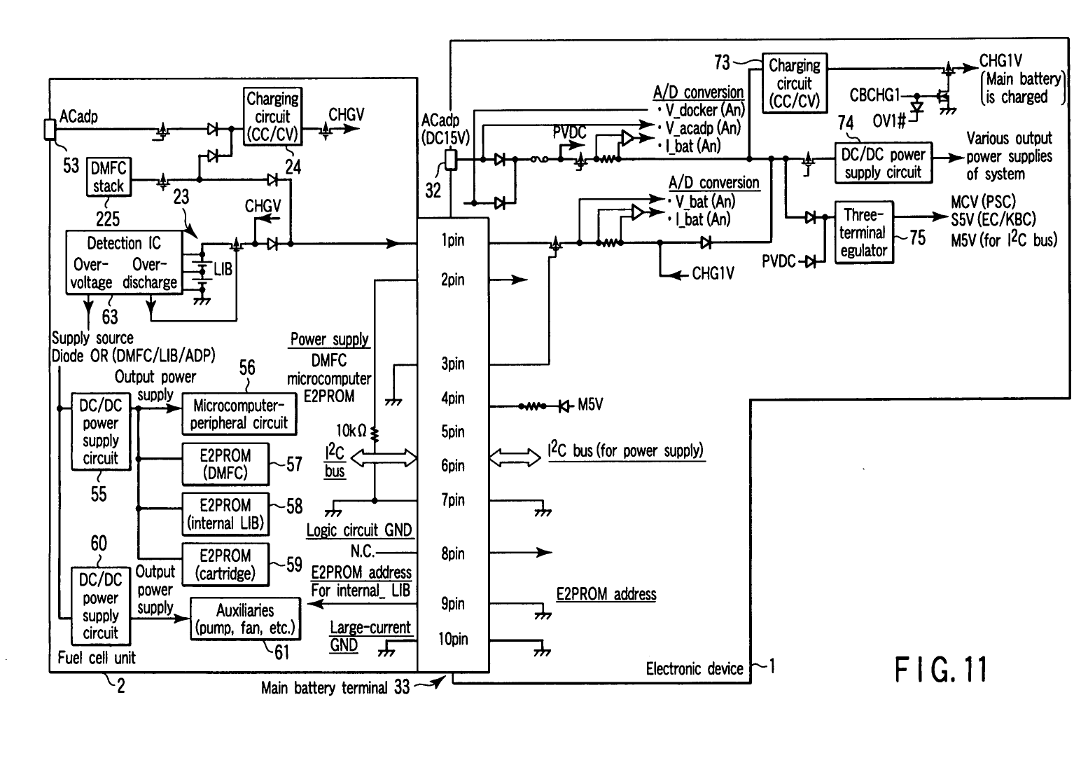

FIG. 11 is a block diagram showing a power supply arrangement in an electronic system according to the fourth embodiment of the present invention. The same reference numerals as in the above embodiments denote the same parts.

In the fourth embodiment, power is supplied from a fuel cell unit 2 to an electronic device 1 by utilizing an existing main battery terminal 33 (identical to the main battery terminal 33 shown in FIG. 9) attached to the main body of the electronic device 1. The main battery terminal 33 is a battery connector for originally connecting a main battery for the electronic device 1.

In the fourth embodiment, the circuit arrangement in the fuel cell unit 2 is similar to that in the fuel cell unit 2 in the first embodiment (for example, a secondary battery 23 is installed in the fuel cell unit 2). In the fourth embodiment, however, power from a DMFC cell stack 225 and power from the secondary battery 23 are selectively supplied to an existing pin (1pin) of the main battery terminal 33 via a diode OR circuit, and supplied to the electronic device 1 via the pin. In this case, no DC/DC power supply circuit is required.

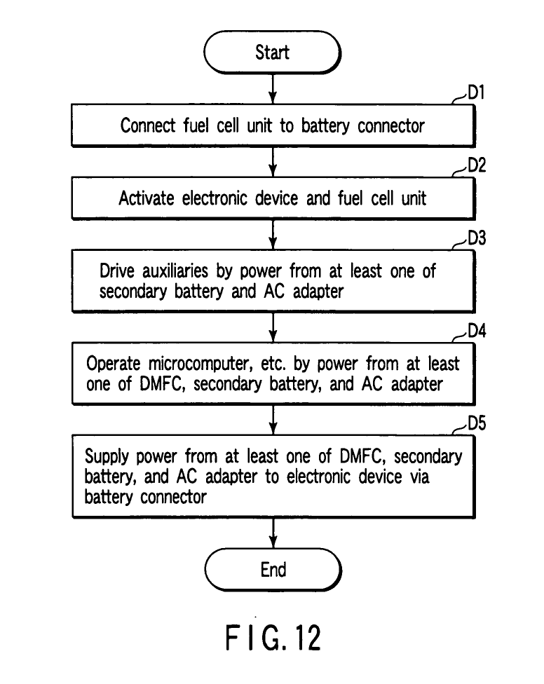

Power supply operation in the fourth embodiment will be explained with reference to the flow chart of FIG. 12.

When the fuel cell unit 2 is connected to the main battery terminal (battery connector) 33 (step D1) and the electronic device 1 and fuel cell unit 2 are activated (step D2), auxiliaries 61 are driven by power from at least one of the secondary battery and AC adapter (step D3). Consequently, the DMFC cell stack 225 is activated.

A microcomputer peripheral circuit 56 and the like operate by power from at least one of the DMFC cell stack 225, secondary battery 23, and AC adapter (step D4). Power from at least one of the DMFC cell stack 225, secondary battery 23, and AC adapter is supplied to the electronic device 1 via the main battery terminal 33 (step D5).

According to the fourth embodiment, power can be supplied from the fuel cell unit 2 to the electronic device 1 by using the existing main battery terminal attached to the main body of the electronic device 1. In this case, the system can be implemented with a simple arrangement without any great circuit change in the existing electronic device 1. The main battery and fuel cell unit 2 can be selectively connected via the main battery terminal, and thus the convenience for the user improves. The safety can be enhanced by cooperation between the electronic device 1 and the fuel cell unit 2 via communication.

(Fifth Embodiment)

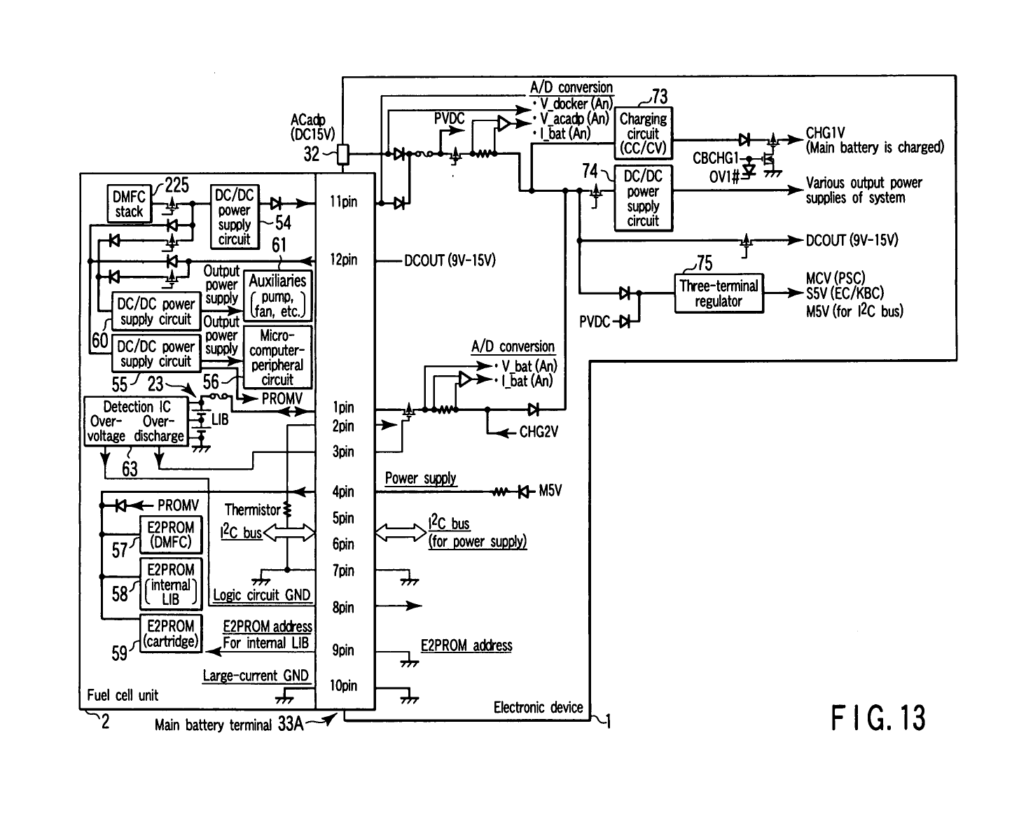

FIG. 13 is a block diagram showing a power supply arrangement in an electronic system according to the fifth embodiment of the present invention. The same reference numerals as in the above embodiments denote the same parts.

In the fifth embodiment, similar to the above-described fourth embodiment (FIG. 11), power is supplied from a fuel cell unit 2 to an electronic device 1 by utilizing an existing main battery terminal attached to the main body of the electronic device 1. The main battery terminal is provided with new pins (11pin and 12pin) for power supply in addition to existing pins. In this manner, the fifth embodiment adopts a main battery terminal 33A expanded from an existing main battery terminal.

In activating the fuel cell unit 2, power for driving auxiliaries is supplied from the electronic device 1 via the pin (12pin) newly attached to the main battery terminal 33A. Power can also be supplied from the electronic device 1 via the existing pin (12pin) of the main battery terminal 33A to a microcomputer and the like in the fuel cell unit 2. Moreover, power can be supplied from the electronic device 1 to a DMFC E²PROM 57, secondary battery E²PROM 58, and cartridge E²PROM 59 via a pin (4pin) newly attached to the main battery terminal 33A.

A DC/DC power supply circuit 54 in the fuel cell unit 2 generates power of a voltage necessary for the operation of the electronic device 1 from power supplied from a DMFC cell stack 225, and outputs the generated power. Power output from the DC/DC power supply circuit 54 is supplied to the electronic device 1 via the pin (11pin) newly attached to the main battery terminal 33A.

The electronic device 1 charges a secondary battery 23 via an existing pin (1pin) of the main battery terminal 33A. The secondary battery 23 supplies power to the electronic device 1.

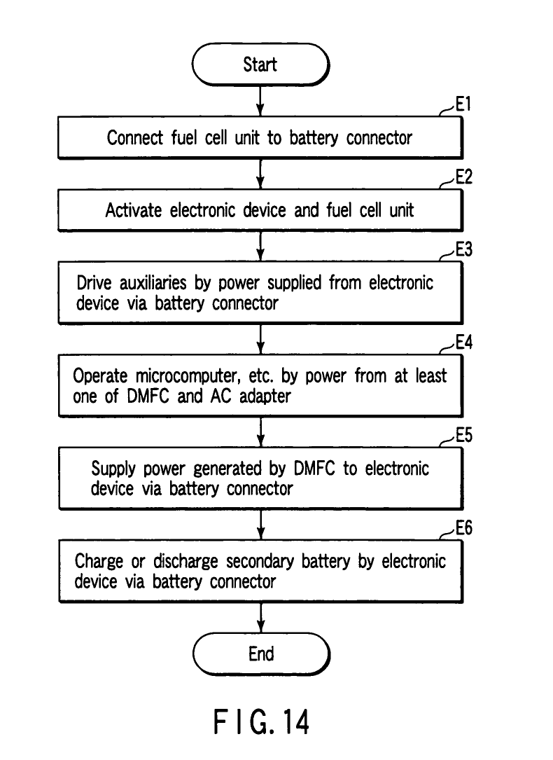

Power supply operation in the fifth embodiment will be explained with reference to the flow chart of FIG. 14.

When the fuel cell unit 2 is connected to the main battery terminal (battery connector) 33A (step E1) and the electronic device 1 and fuel cell unit 2 are activated (step E2), auxiliaries 61 are driven by power supplied from the electronic device 1 via the main battery terminal 33A (step E3). As a result, the DMFC cell stack 225 is activated.

A microcomputer peripheral circuit 56 and the like operate by power from at least one of the DMFC cell stack 225 and AC adapter (step E4). Power generated by the DMFC cell stack 225 is supplied to the electronic device 1 via the main battery terminal 33A (step E5).

The electronic device 1 charges the secondary battery 23 via the existing pin (lpin) of the main battery terminal 33A, and the secondary battery 23 supplies power to the electronic device 1 (step E6).

According to the fifth embodiment, the existing main battery terminal with new pins in the main body of the electronic device 1 can be used to activate the auxiliaries of the fuel cell unit 2 by power from the electronic device 1, and supply power from the fuel cell unit 2 to the electronic device 1. In this case, the system can be implemented with a simple arrangement without any great circuit change in the existing electronic device 1. Each power supply source in the fuel cell unit 2 is connected to the electronic device 1 via an independent path, thereby simplifying the circuit arrangement. Since the main battery and fuel cell unit 2 can be selectively connected via the main battery terminal, the convenience for the user improves. The safety can be enhanced by cooperation between the electronic device 1 and the fuel cell unit 2 via communication.

(Sixth Embodiment)

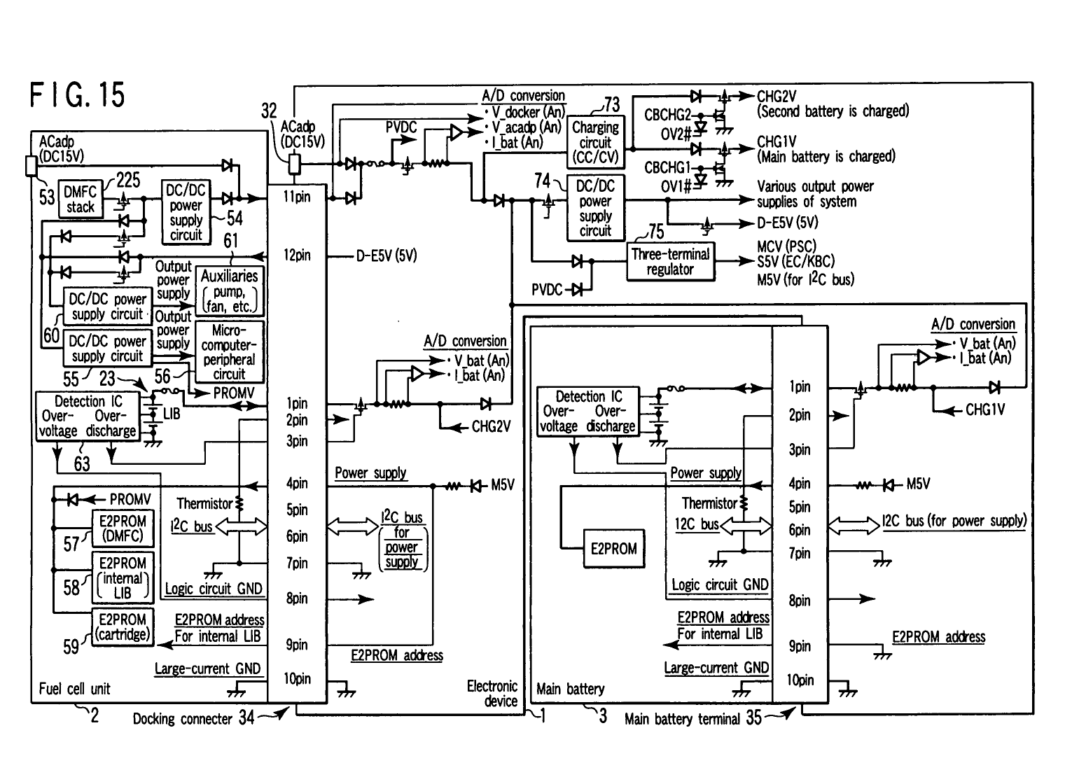

FIG. 15 is a block diagram showing a power supply arrangement in an electronic system according to the sixth embodiment of the present invention. The same reference numerals as in the above embodiments denote the same parts.

In the sixth embodiment, power is supplied from a fuel cell unit 2 to an electronic device 1 by utilizing an existing port replicator connector (docking connector) 34 attached to the main body of the electronic device 1. The port replicator connector (docking connector) 34 is a connector for originally connecting a port replicator for expanding the communication function or the like.

In the sixth embodiment, the circuit arrangement in the fuel cell unit 2 is similar to that in the fuel cell unit 2 in the fifth embodiment. In the sixth embodiment, the port replicator connector (docking connector) 34 is equipped with new pins (11pin and 12pin) for power supply in addition to existing pins.

In activating the fuel cell unit 2, power for driving auxiliaries is supplied from the electronic device 1 via the pin (12pin) newly attached to the docking connector 34. Power can also be supplied from the electronic device 1 via the existing pin (12pin) of the docking connector 34 to a microcomputer and the like in the fuel cell unit 2. Furthermore, power can be supplied from the electronic device 1 to a DMFC E²PROM 57, secondary battery E²PROM 58, and cartridge E²PROM 59 via a pin (4pin) newly attached to the docking connector 34.

A DC/DC power supply circuit 54 in the fuel cell unit 2 generates power of a voltage necessary for the operation of the electronic device 1 from power supplied from a DMFC cell stack 225, and outputs the generated power. Power output from the DC/DC power supply circuit 54 is supplied to the electronic device 1 via the pin (11pin) newly attached to the docking connector 34.

The electronic device 1 charges a secondary battery 23 via an existing pin (lpin) of the main battery terminal 33A. The secondary battery 23 supplies power to the electronic device 1.

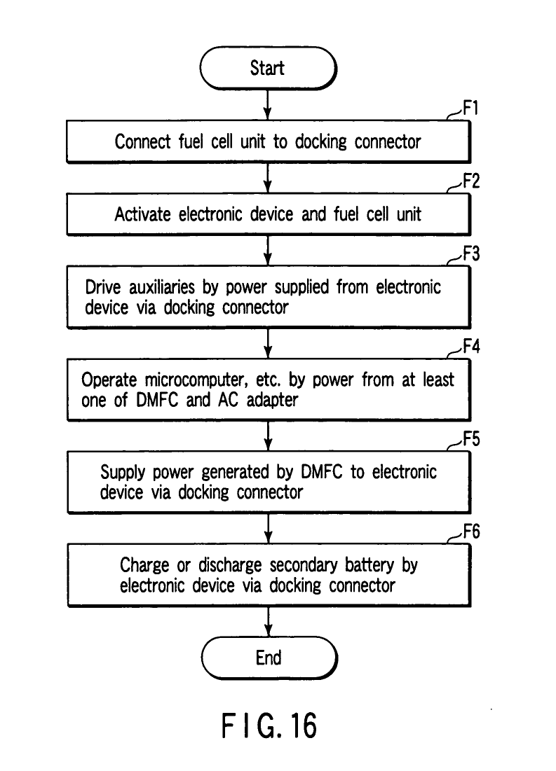

Power supply operation in the sixth embodiment will be explained with reference to the flow chart of FIG. 16.

When the fuel cell unit 2 is connected to the docking connector 34 serving as a port replicator connector (step F1) and the electronic device 1 and fuel cell unit 2 are activated (step F2), auxiliaries 61 are driven by power supplied from the electronic device 1 via the docking connector 34 (step F3). As a result, the DMFC cell stack 225 is activated.

A microcomputer peripheral circuit 56 and the like operate by power from at least one of the DMFC cell stack 225 and AC adapter (step F4). Power generated by the DMFC cell stack 225 is supplied to the electronic device 1 via the docking connector 34 (step F5).

The electronic device 1 charges the secondary battery 23 via the existing pin (1pin) of the docking connector 34, and the secondary battery 23 supplies power to the electronic device 1 (step F6).

According to the sixth embodiment, the existing port replicator connector (docking connector) with new pins in the main body of the electronic device 1 can be used to activate the auxiliaries of the fuel cell unit 2 by power from the electronic device 1, and supply power from the fuel cell unit 2 to the electronic device 1. In this case, the system can be implemented with a simple arrangement without any great circuit change in the existing electronic device 1. Each power supply source in the fuel cell unit 2 is connected to the electronic device 1 via an independent path, thus simplifying the circuit arrangement. Since the port replicator and fuel cell unit 2 can be selectively connected via the port replicator connector (docking connector), the convenience for the user improves. The safety can be enhanced by cooperation between the electronic device 1 and the fuel cell unit 2 via communication.

As has been described in detail above, the present invention can simplify the circuit arrangement in the electronic system while ensuring safety.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An electronic system comprising:
an electronic device having an AC adapter connection terminal; and
a cell unit having a fuel cell capable of generating power by a chemical reaction and a battery, the cell unit being configured to supply at least one of power from the fuel cell and power from the battery to the electronic device via the AC adapter connection terminal.

2. The system according to claim 1, wherein:
the cell unit and the electronic device have communication portions to communicate with each other; and
the electronic device acquires information representing a state of a power supply of the cell unit via the communication portion and performs control on at least a power supply of the electronic device in accordance with the information.

3. An electronic system comprising:
an electronic device having a connector to connect an external device; and
a cell unit having a fuel cell capable of generating power by a chemical reaction, the cell unit being connectable to the electronic device via the connector, configured to receive power for driving an auxiliary of the fuel cell in activating the cell unit from the electronic device via a first pin of the connector, and configured to supply power generated by the fuel cell to the electronic device via a second pin of the connector.

4. The system according to claim 3, wherein the connector is a docking connector to connect a docker.

5. The system according to claim 3, wherein the cell unit receives power for operating a specific potion in the cell unit from the electronic device via a third pin of the connector.

6. The system according to claim 3, wherein the cell unit includes a dry battery capable of supplying power for driving the auxiliary in activating the cell unit.

7. An electronic system comprising:
an electronic device having a battery connector to connect a battery; and
a cell unit having a fuel cell capable of generating power by a chemical reaction and a battery, the cell unit being connectable to the electronic device via the battery connector, and configured to supply at least one of power from the fuel cell and power from the battery to the electronic device via a specific pin of the battery connector.

8. An electronic system comprising:
an electronic device having a battery connector to connect a battery; and
a cell unit having a fuel cell capable of generating power by a chemical reaction and a battery, the cell unit being connectable to the electronic device via the battery connector, configured to supply power generated by the fuel cell to the electronic device via a first pin of the battery connector, and configured to exchange power charged/discharged by the battery with the electronic device via a second pin of the battery connector.

9. The system according to claim 8, wherein the cell unit receives power for driving an auxiliary for the fuel cell in activating the cell unit from the electronic device via a third pin of the battery connector.

10. The system according to claim 8, wherein the cell unit receives power for operating a specific potion in the cell unit from the electronic device via a fourth pin of the battery connector.

11. An electronic system comprising:
an electronic device having a connector to connect an external device; and
a cell unit having a fuel cell capable of generating power by a chemical reaction and a battery, the cell unit being connectable to the electronic device via the connector, configured to supply power generated by the fuel cell to the electronic device via a first pin of the connector, and configured to exchange power charged/discharged by the battery with the electronic device via a second pin of the battery connector.

12. The system according to claim 11, wherein the cell unit receives power for driving an auxiliary for the fuel cell in activating the cell unit from the electronic device via a third pin of the connector.

13. The system according to claim 11, wherein the cell unit receives power for operating a specific portion in the cell unit from the electronic device via a fourth pin of the connector.

14. A power supply method applied to an electronic system including an electronic device and a cell unit, the electronic device having an AC adapter connection terminal, and the cell unit having a fuel cell capable of generating power by a chemical reaction and a battery, the method comprising:
supplying at least one of power from the fuel cell and power from the battery in the cell unit to the electronic device via the AC adapter connection terminal;
transmitting information representing a state of a power supply of the cell unit to the electronic device via a communication means; and
performing control on at least a power supply of the electronic device in accordance with the information transmitted via the communication means.

15. A power supply method applied to an electronic system including an electronic device and a cell unit, the electronic device having a connector to connect an external device, and the cell unit having a fuel cell capable of generating power by a chemical reaction, the method comprising:
connecting the cell unit to the electronic device via the connector;
driving an auxiliary for the fuel cell in activating the cell unit by power supplied from the electronic device via a first pin of the connector; and
supplying power generated by the fuel cell to the electronic device via a second pin of the connector.

16. The method according to claim 15, further comprising driving the auxiliary by a dry battery when no power is supplied from the electronic device via the first pin of the connector in activating the cell unit.

17. A power supply method applied to an electronic system including an electronic device and a cell unit, the electronic device having a battery connector to connect a battery, the cell unit having a fuel cell capable of generating power by a chemical reaction and a battery, the method comprising:
connecting the cell unit to the electronic device via the battery connector; and
supplying at least one of power generated by the fuel cell and power generated by the battery to the electronic device via a specific pin of the battery connector.

18. A power supply method applied to an electronic system including an electronic device and a cell unit, the electronic device having a battery connector to connect a battery, the cell unit having a fuel cell capable of generating power by a chemical reaction and a battery, the method comprising:
connecting the cell unit to the electronic device via the battery connector;
supplying power generated by the fuel cell to the electronic device via a first pin of the battery connector; and
exchanging power charged/discharged by the battery with the electronic device via a second pin of the battery connector.

19. A power supply method applied to an electronic system including an electronic device and a cell unit, the electronic device having a connector to connect an external device, and the cell unit having a fuel cell capable of generating power by a chemical reaction and a battery, the method comprising:
connecting the cell unit to the electronic device via the connector;
supplying power generated by the fuel cell to the electronic device via a first pin of the connector; and
exchanging power charged/discharged by the battery with the electronic device via a second pin of the battery connector.
